(19) United States
(12) Patent Application Publication
(10) Pub. No.: US 2006/0034406 A1
(43) Pub. Date: Feb. 16, 2006

(54) Apparatus for timing recovery and method thereof

(75) Inventor: Tae Won Lee, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/204,089

(22) Filed: Aug. 16, 2005

(30) Foreign Application Priority Data
Aug. 16, 2004 (KR) 10-2004-0064397

(51) Int. Cl. H04L 7/00

(52) U.S. Cl. 375/355

(57) ABSTRACT

The present invention provides an apparatus for timing recovery and method thereof. The present invention includes the steps of obtaining a symbol sample value by sampling a received baseband signal with a symbol sample rate and by performing a front-end processing on the sampled signal in a digital area, finding a differential value of the symbol sample value, generating a decision symbol error value by finding a difference between the symbol sample value and a decision value decided through the symbol sample value, finding a conjugate value of the decision symbol error value to multiply the conjugate value by the differential value, and generating a timing error value by calculating a real number value of the multiplied signal and recovering a timing error of the received signal through the generated timing error value. Accordingly, the tracking mode employing MMSE timing recovery in performing timing recovery is provided to enhance tracking performance for ghost. And, the present invention uses the channel equalizer of the symbol sample rate to reduce a hardware cost.

This application claims the benefit of the Korean Patent Application No. 10-2004-0064397 filed on Aug. 16, 2004, which is hereby incorporated by reference.

### BACKGROUND OF THE INVENTION

1. Field of the Invention

The present invention relates to timing recovery of a digital transceiver system, and more particularly, to an apparatus for timing recovery and method thereof, in which timing is recovered using an MMSE timing error detector of a symbol sample rate.

2. Discussion of the Related Art

Generally, symbol synchronization of the QAM (quadrature amplitude modulation) receiver selected as the standard of digital TV cable channel transmission system is a process of reproducing a clock of a symbol column, which is called clock synchronization or clock reproduction. The symbol synchronization intends to accurately presume a symbol transition time point in a receiver based on a received data column. Hence, the symbol synchronization is mandatory for demodulation of a digital transceiver system. A configuration of a general QAM demodulator including a symbol synchronization unit is shown in FIG. 1.

Referring to FIG. 1, a QAM demodulator according to a related art consists of a multiplier 111 outputting a baseband signal by multiplying an input signal by a signal having a predetermined frequency outputted from a numerical control oscillator (NCO) 121, a sampler 113 receiving to sample the baseband signal outputted from the multiplier 111, a baseband signal processing block 117 receiving a signal outputted from the sampler 113 to perform signal processing such as decoding and the like, a carrier recovery block & channel equalizer 119 for distortion compensation of a signal outputted from the baseband signal processing block 117, and a symbol synchronization (recovery) unit 115 receiving a signal outputted from the baseband signal processing block 117 to correctly presume a symbol transition time point from the received signal.

The symbol synchronization block 115 is generally situated at a front end of the carrier synchronization block & channel equalizer 119 to transfer synchronized symbol data.

Hence, a convergence characteristic of symbol synchronization affects a convergence characteristic of the carrier synchronization block & channel equalizer in a rear end. To provide a receiver with better tracking performance, symbol synchronization recovery of MMSE (minimum mean squared error) using symbol synchronization information is used for a rear end of the channel equalizer 119. The MMSE symbol recovery algorithm and its configuration are exemplarily shown in FIG. 2.

FIG. 2 is a block diagram of a configuration according to a general MMSE symbol recovery algorithm.

Referring to FIG. 2, a received baseband signal R(t) is sampled at the Nyquist sample rate to become Qₖ(τₖ) through a front-end processing 211 in a digital area. In the signal Qₖ(τₖ), ‘k’ means a k^{th} sample and ‘τₖ’ indicates a k^{th} sample timing error. Hence, the signal Qₖ(τₖ) means the k^{th} sample having a timing error of τₖ.

In this case, τₖis ideally constant to an optimal sampling phase but substantially has a timing jitter. So, timing recovery is generally understood as the scheme of adjusting the τₖ repeatedly.

Hence, the MMSE timing recovery adjusts the τₖ to minimize an expectation value of a squared error between an input symbol Qₖ(τₖ) and an accurate symbol Aₖ, which is shown in Formula 1.
E[|Eₖ(τₖ)|²]=E[|Qₖ(τₖ)−Aₖ|²] [Formula 1]

The MMSE timing recovery can use criterion used for an adaptive equalizer and stochastic gradient algorithm in trying to find an optimal timing phase. Hence, if a receiver can use the accurate symbol Aₖ, the criterion directly minimizes a decision error to get closer to a minimum error probability.

Unfortunately, the input Qₖ(τₖ) of a decision device, which is a complicated non-linear function of the timing phase τₖ, is difficult to be defined as a unique minimum MSE timing phase unlike the case of the adaptive equalizer. So, a trial to minimize the expectation value of the squared error can be made through the method of adjusting the timing phase.

A reverse direction gradient minimizing the expectation value of the squared error is provided as a complex function Eₖ(τₖ) of a real number variable τₖ, which is expressed in Formula 2.

$$\frac{\partial }{\partial {τ}_{k}} E [ {\vert {E}_{k} ( {τ}_{k} ) \vert}^{2} ] = E [ \frac{\partial }{\partial {τ}_{k}} {\vert {E}_{k} ( {τ}_{k} ) \vert}^{2} ] \qquad [ Formula 2 ]$$

If developing Formula 2, Formula 3 is found as follows:

$$\frac{\partial }{\partial {τ}_{k}} \text{\textbar} {{E}_{k} ( {τ}_{k )} \vert}^{2} = 2 Re \{ {E}_{k}^{*} ( {τ}_{k} ) \frac{\partial {E}_{k} ( {τ}_{k} )}{\partial {τ}_{k}} \} , \qquad [ Formula 3 ]$$

since Aₖ is not a function of τₖ, it can be expressed as Formula 4.

$$\frac{\partial {E}_{k} ( {τ}_{k} )}{\partial {τ}_{k}} = \frac{\partial {Q}_{k} ( {τ}_{k} )}{\partial {τ}_{k}} \qquad [ Formula 4 ]$$

Hence, to adjust the timing phase in the reverse gradient direction, Formula 5 is used.

$${τ}_{k + 1} = {τ}_{k} - α Re \{ {E}_{k}^{*} ( {τ}_{k} ) \frac{\partial {Q}_{k} ( {τ}_{k} )}{\partial {τ}_{k}} \} \qquad [ Formula 5 ]$$

In this case, since Qₖ(τₖ) is a sample of the Nyquist sample rate, it can be expressed as Formula 6.

$$\frac{\partial {Q}_{k} ( {τ}_{k} )}{\partial {τ}_{k}} = {Q}_{k} ( {τ}_{k} ) * {d}_{k} \qquad [ Formula 6 ]$$

In this case, ‘dₖ’ corresponds to an impulse response of a differential filter. The differential filter can be substantially approximated to a FIR (finite impulse response) filter 213. By simple approximation using the FIR filter 213, Formula 7 can be obtained.

$${τ}_{k + 1} = {τ}_{k} + α {Z}_{k} ( {τ}_{k} ) \\ {Z}_{k} ( {τ}_{k} ) = - Re \{ [ {Q}_{k} ( {τ}_{k} ) - \begin{matrix}Λ \\ {A}_{k}\end{matrix} ] [ {Q}_{k + 1} ( {τ}_{k} ) - {Q}_{k - 1} ( {τ}_{k} ) ] \} \qquad [ Formula 7 ]$$

Thus, the MMSE timing recovery according to the related art needs the output signal of the channel equalizer which is Nyquist-sampled to find the differential value (using a frequency twice greater than that of a received signal). This is explained in detail with reference to FIG. 4 as follows.

FIG. 4 shows samples of a related art if a decision device input Qₖ(τₖ) is the Nyquist sample rate.

In (a) of FIG. 4, there is no timing phase error. In (b) of FIG. 4, a timing phase is later than an accurate phase. In (c) of FIG. 4, a timing phase is faster than an accurate phase.

Hence, like (b) or (c) of FIG. 4, in case that there occurs a difference between the timing phase and the accurate phase, the recovery is possible only if it is known whether the phase difference is earlier or later than the accurate phase. For this, a differential value (gradient) using intermediate symbol sample values (Qₖ₊₁(τₖ), Qₖ₋₁(τₖ): transition values) is needed (aforesaid stochastic gradient algorithm).

Namely, a negative differential value indicates that the phase difference is later than the accurate phase. And, a positive differential value indicates that the phase difference is earlier than the accurate phase.

In order to find the differential value using the intermediate symbol sample values, sampling should be performed using the frequency twice greater than that of a received signal according the Nyquist sample rate.

Hence, a sample at the Nyquist sample rate should be processed in a front-end processing of a digital area. Specifically, a hardware cost for an equalizer occupying 60˜70% of a configuration of a receiver to handle the sample data of the Nyquist sample rate is raised.

### SUMMARY OF THE INVENTION

Accordingly, the present invention is directed to an apparatus for timing recovery and method thereof that substantially obviate one or more problems due to limitations and disadvantages of the related art.

An object of the present invention is to provide an apparatus for timing recovery and method thereof, by which a hardware cost of an equalizer is saved using a symbol sample rate corresponding to a half of the Nyquist sample rate and by which an MMSE timing recovery method of enhancing tracking performance of a timing recovery block is proposed.

Another object of the present invention is to provide an apparatus for timing recovery and method thereof, by which an acquisition mode and a tracking mode can be switched according to a channel status by estimating an SNR.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a timing error recovery method according to the present invention includes the steps of obtaining a symbol sample value by sampling a received baseband signal with a symbol sample rate and by performing a front-end processing on the sampled signal in a digital area, finding a differential value of the symbol sample value, generating a decision symbol error value by finding a difference between the symbol sample value and a decision value decided through the symbol sample value, finding a conjugate value of the decision symbol error value to multiply the conjugate value by the differential value, and generating a timing error value by calculating a real number value of the multiplied signal and recovering a timing error of the received signal through the generated timing error value.

In another aspect of the present invention, a timing error recovery method includes the steps of detecting a timing error value by MMSE timing error detection using a signal sampled with a symbol sample rate, tuning a symbol synchronization by receiving the detected timing error value and by adjusting a symbol-to-symbol transition time point, and calculating an SNR value for a switching between an acquisition mode and a tracking mode from the sampled signal.

In another aspect of the present invention, a timing error recovery apparatus includes a differential value calculating unit a gradient between sample values of a signal sampled with a symbol sample rate, a symbol error decision unit outputting a decision symbol error value by finding a difference between the symbol sample value and a decision value decided through the symbol sample value, a conjugate operation unit finding a conjugate value of the decision symbol error value, a multiplier multiplying the conjugate value by the differential value, a real number seeking operation unit outputting a timing error signal by calculating a real number value of an output value of the multiplier, and a symbol synchronization unit tuning a symbol synchronization by receiving the timing error signal and by adjusting a symbol-to-symbol transition time point.

In a further aspect of the present invention, a timing error recovery apparatus includes a timing error detector receiving a signal sampled with a symbol sample rate to detect a timing error value using MMSE timing error detection, a symbol synchronization unit tuning a symbol synchronization by receiving the detected timing error value and by adjusting a symbol-to-symbol transition time point, and an SNR estimator calculating an SNR value for a switching between an acquisition mode and a tracking mode from the sampled signal.

Therefore, by the present invention, a tracking mode employing MMSE timing recovery is provided to enhance tracking performance for a ghost and a hardware cost is lowered using a channel equalizer of a symbol sample rate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a QAM demodulator including a symbol synchronization block according to a related art;

FIG. 2 is a block diagram of a configuration according to a general MMSE symbol recovery algorithm;

FIG. 3 is a diagram of samples when a decision device input Qₖ(τₖ) is the Nyquist sample rate according to a related art;

FIG. 4 is a block diagram of a timing error detector using stochastic gradient algorithm by a symbol sample rate according to the present invention;

FIG. 5 and FIG. 6 are diagrams of samples when a decision device input Qₖ(τₖ) is a symbol sample rate; and

FIG. 7 is a block diagram of a receiver having an acquisition mode and a tracking mode.

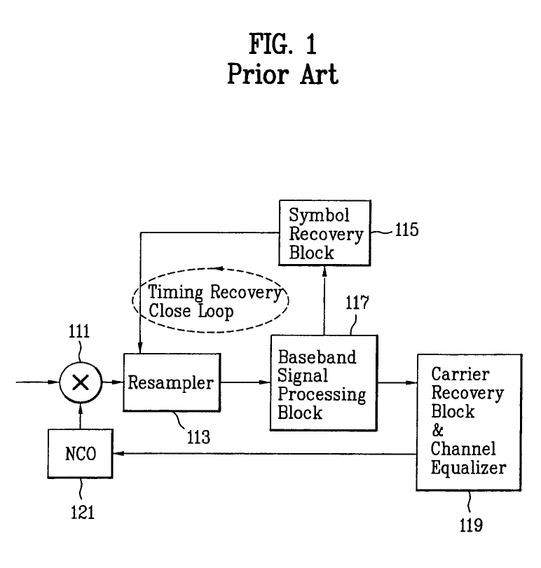

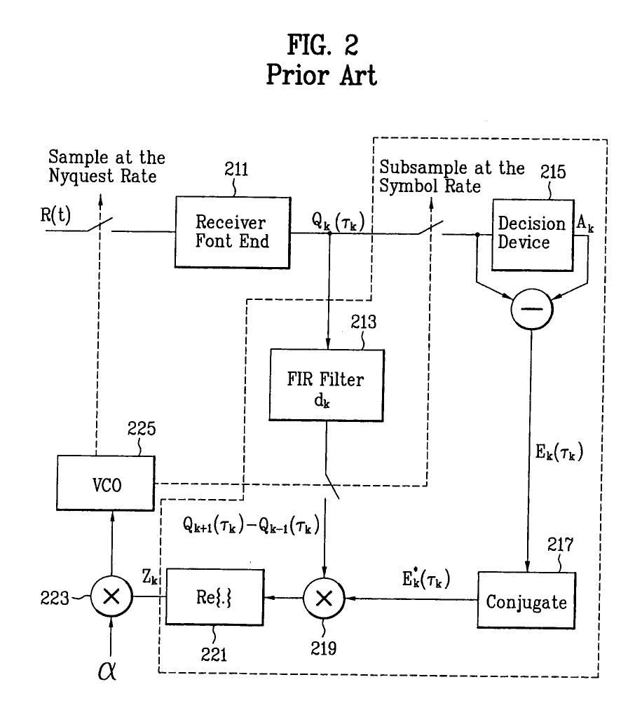

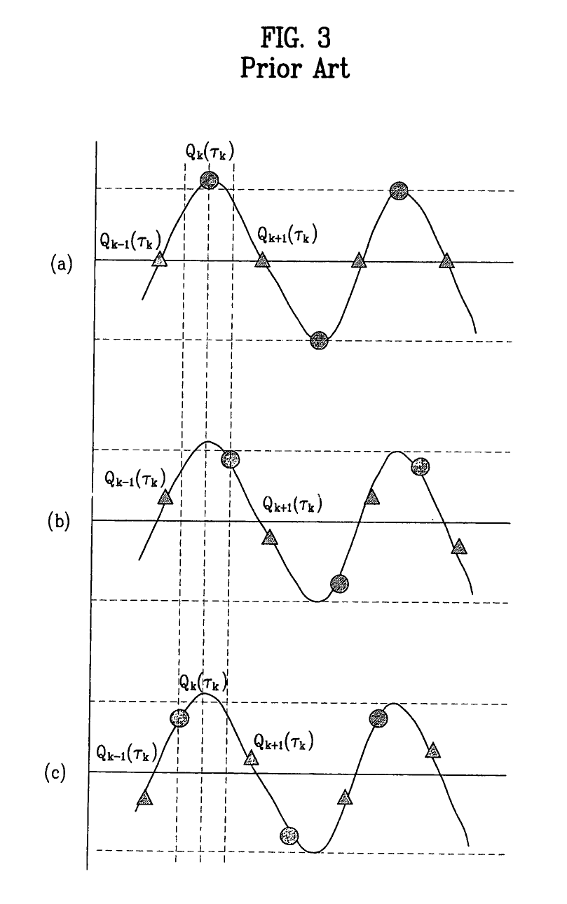

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Besides, the terms used in the present invention are mainly selected from currently usable global and general terms. Yet, most appropriate terms are arbitrarily used by the applicant to keep up with the appearance of new technologies. And, the meanings of the arbitrarily used terms will be clearly explained in the corresponding description. Hence, in apprehending the present invention, the present invention should be understood not by the simple names of the terms but by the meanings of the terms.

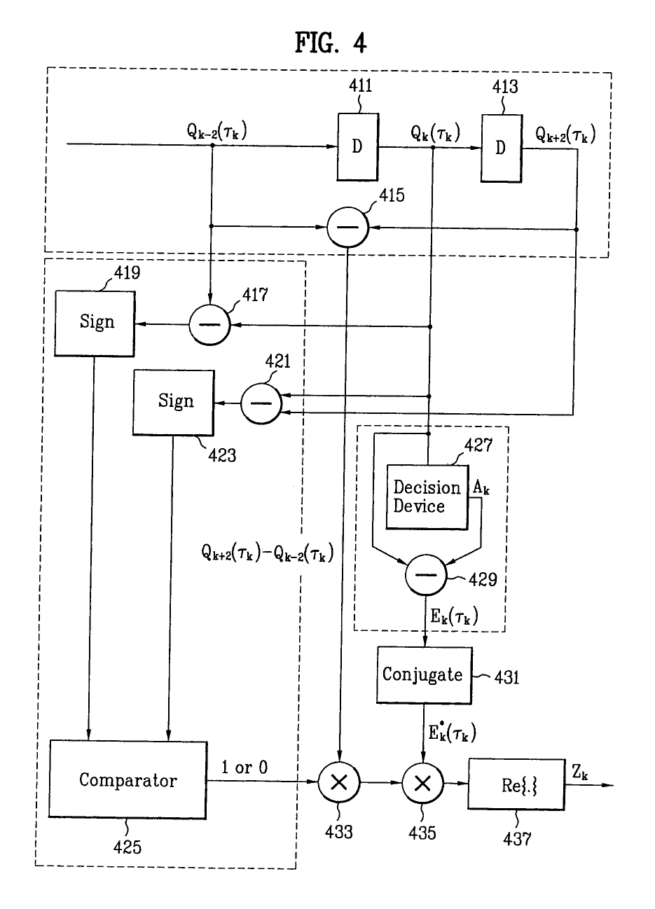

FIG. 4 is a block diagram of a timing error detector using stochastic gradient algorithm by a symbol sample rate according to the present invention.

Referring to FIG. 4, a timing error detector according to the present invention finds a differential value in MMSE timing recovery using symbol sample values conditionally instead of intermediate sample values.

Namely, a differential value is found using the symbol sample values Qₖ₋₂(τₖ) , Qₖ(τₖ) and Qₖ₊₂(τₖ). If the differential value is calculated using the symbol sample values only, it is able to use a channel equalizer operated not by the Nyquist sample rate but by a symbol sample rate.

Specifically, a received baseband signal R(t) is sampled by a symbol sample rate and is then outputted as a signal Qₖ₋₂(τₖ) through a front-end processing such as channel equalization in a digital area and the like.

The signal Qₖ₋₂(τₖ) is inputted and is then delayed by delayers 411 and 413 to obtain signals Qₖ(τₖ) and Qₖ₊₂(τₖ).

A difference between the signals Qₖ(τₖ) and Qₖ₊₂(τₖ) is found by a subtracter 415 to be outputted as a differential value Qₖ₊₂(τₖ)−Qₖ₋₂(τₖ) to a multiplier 433. Hence, the delayers 411 and 413 and the subtracter 415 configure a differential value calculating unit.

Meanwhile, a difference between the signals Qₖ₋₂(τₖ) and Qₖ(τₖ) is found by a subtracter 417. And, a sign according to the difference value is decided by a sign block 419 to be inputted to a comparator 425. A difference between the signals Qₖ(τₖ) and Qₖ₊₂(τₖ) is found by a subtracter 421. And, a sign according to the difference value is decided by a sign block 423 to be inputted to the comparator 425.

Hence, the comparator 425 receives the signs according to the difference values, respectively to compare sizes of the signals Qₖ₋₂(τₖ), Qₖ(τₖ) Qₖ₊₂(τₖ).

Therefore, the subtracters 417 and 421, the sign blocks 419 and 423 and the comparator 425 can configure a signal size comparison unit.

As a result of the comparisons, if the signal sizes correspond to Qₖ₋₂(τₖ)≦Qₖ(τₖ)≦Qₖ₊₂(τₖ) or Qₖ₊₂(τₖ)≦Qₖ(τₖ)≦Qₖ₋₂(τₖ), a signal ‘1’ is outputted to a multiplier 433. Otherwise, a signal ‘0’ is outputted to the multiplier 433.

If Qₖ₋₂(τₖ)≦Qₖ(τₖ)≦Qₖ₊₂(τₖ) or Qₖ₋₊(τₖ)≦Qₖ(τₖ)≦Qₖ₋₂(τₖ), i.e., only if the sizes have a predetermined ascending or descending order pattern according to a sampled sequence of the sample values, the found differential value Qₖ₊₂(τₖ)−Qₖ₋₂(τₖ) is applicable. With such a condition, an accurate result value associated with a timing error can be obtained.

Meanwhile, a difference between a signal Qₖ(τₖ) inputted to a decision device 427 and the value Aₖ decided by the decision device 427 is found by a subtracter 429 to become a decision symbol error Qₖ(τₖ)−Aₖ_{₌}Eₖ(τₖ).

Hence, the decision device 427 and the subtracter 429 configure a symbol error decision unit. And, a conjugate root Eₖ*(τₖ) of the decision symbol error Eₖ(τₖ) decided by the symbol error decision unit is found by a conjugate operation block 431.

The conjugate root Eₖ*(τₖ) and the differential value Qₖ₊₂(τₖ)−Qₖ₋₂(τₖ) outputted from the multiplier 433 are multiplied together by a multiplier 435.

In this case, the differential value outputted from the multiplier 433 will be outputted in case that an output of the comparator 425 is ‘1’.

A real number value of an output of the multiplier 435 is found by a real number seeking operation block 437 to be outputted. And, an output value Zₖ of the real number seeking operation unit 437 corresponds to a timing error value for phase adjustment.

In this case, if the timing error value is negative, it means that the timing phase is later than the accurate phase. If the timing error value is positive, it means that the timing phase is earlier than the accurate phase. This is explained with reference to the attached drawings as follows.

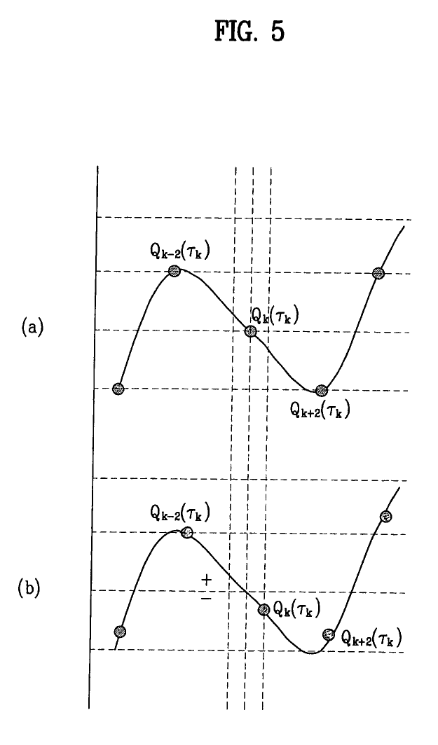

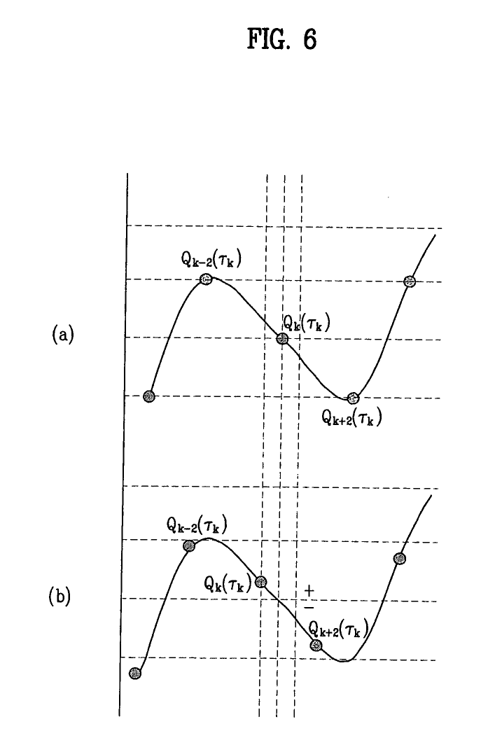

FIG. 5 and FIG. 6 are diagrams of samples when a decision device input Qₖ(τₖ) is a symbol sample rate.

First of all, a case that there is no timing phase error is shown in (a) of FIG. 5. And, a case that a timing phase is later than an accurate phase is shown in (b) of FIG. 5.

Referring to (b) of FIG. 5, in case that a timing phase is later than an accurate phase, a decision symbol error value of Qₖ(τₖ) is negative and a differential value Qₖ₊₂(τₖ)−Qₖ₋₂(τₖ) is negative as well. Hence, a timing error signal as a final output signal becomes negative by an expression of:

$${Z}_{k} ( {τ}_{k} ) = - Re \{ [ {Q}_{k} ( {τ}_{k} ) - \begin{matrix}Λ \\ {A}_{k}\end{matrix} ] [ {Q}_{k + 2} ( {τ}_{k} ) - {Q}_{k - 2} ( {τ}_{k} ) ] \} ,$$

it can be known that the timing phase is later than the accurate phase.

Meanwhile, a case that there is no timing phase error is shown in (a) of FIG. 6. And, a case that a timing phase is earlier than an accurate phase is shown in (b) of FIG. 6.

Referring to (a) of FIG. 6, in case that a timing phase is earlier than an accurate phase, a decision symbol error value of Qₖ(τₖ) is positive and a differential value Qₖ₊₂(τₖ)−Qₖ₋₂(τₖ) is negative. Hence, a timing error signal as a final output signal becomes positive by an expression of:

$${Z}_{k} ( {τ}_{k} ) = - Re \{ [ {Q}_{k} ( {τ}_{k} ) - \begin{matrix}Λ \\ {A}_{k}\end{matrix} ] [ {Q}_{k + 2} ( {τ}_{k} ) - {Q}_{k - 2} ( {τ}_{k} ) ] \} ,$$

it can be known that the timing phase is earlier than the accurate phase.

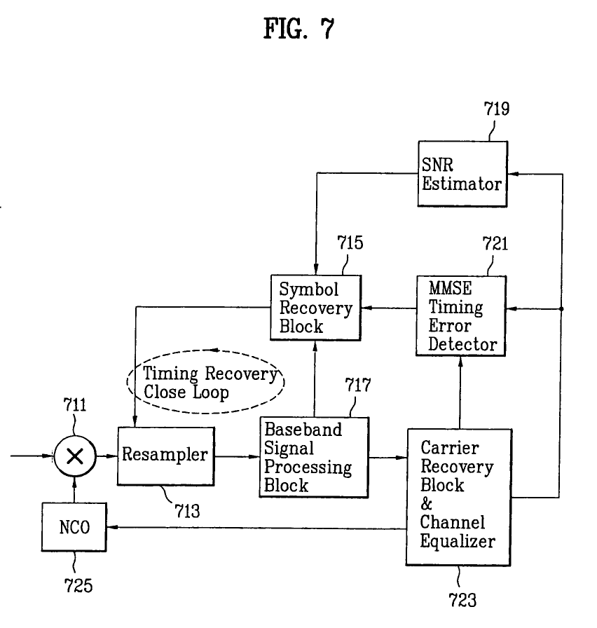

FIG. 7 is a block diagram of a receiver having an acquisition mode and a tracking mode.

An MMSE timing error detector 721 represents the blocks explained in FIG. 4. The MMSE timing error detector 721 receives a signal equalized by a channel equalizer 723 by a symbol sample rate to find a timing error by the method according to the present invention.

The found timing error value is inputted to a symbol synchronization block 715. The symbol synchronization block 715 tunes symbol synchronization in a tracking mode according to the inputted timing error value.

Meanwhile, an SNR estimator 719 is a block that calculates an SNR by receiving a signal outputted from the channel equalizer 723. After having acquired a timing using an input signal of the channel equalizer 723 in the early stage of timing recovery (acquisition mode), the SNR estimator 719 plays a role in switching the MMSE timing error detector 721 of the present invention to a tracking mode if an SNR value calculated by the SNR estimator 719 is equal to or greater than a predetermined value.

The present invention is applicable to communications fields enabling MMSE timing recovery such as a QPSK/QAM receiver and the like.

Accordingly, the present invention provides the following effects or advantages.

First of all, the tracking mode employing MMSE timing recovery in performing timing recovery is provided to enhance tracking performance for ghost. And, the present invention uses the channel equalizer of the symbol sample rate to reduce a hardware cost.

Secondly, the present invention enables switching between the acquisition mode and the tracking mode using the SNR estimator, thereby enhancing reliability of the receiver.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A timing error recovery method comprising the steps of:
obtaining a symbol sample value by sampling a received baseband signal with a symbol sample rate and by performing a front-end processing on the sampled signal in a digital area;
finding a differential value of the symbol sample value;
generating a decision symbol error value by finding a difference between the symbol sample value and a decision value decided through the symbol sample value;
finding a conjugate value of the decision symbol error value to multiply the conjugate value by the differential value; and
generating a timing error value by calculating a real number value of the multiplied signal and recovering a timing error of the received signal through the generated timing error value.

2. The timing error recovery method of claim 1, the differential value finding step comprising the steps of:
delaying the symbol sample value; and
finding the differential value of the symbol sample value by finding a difference between the delayed signals.

3. The timing error recovery method of claim 1, further comprising a step of comparing a size of the symbol sample value of the signal sampled with the symbol sample rate.

4. The timing error recovery method of claim 3, wherein the differential value and the conjugate value are multiplied together if the compared size of the symbol sample value has a predetermined ascending or descending order pattern according to a sampled sequence.

5. A timing error recovery method comprising the steps of:
obtaining a symbol sample value by sampling a received baseband signal with a symbol sample rate and by performing a front-end processing in a digital area;
detecting a timing error value by MMSE timing error detection using the symbol sample value; and
recovering a timing error of the received signal using the detected timing error value.

6. A timing error recovery method comprising the steps of:
detecting a timing error value by MMSE timing error detection using a signal sampled with a symbol sample rate;
tuning a symbol synchronization by receiving the detected timing error value and by adjusting a symbol-to-symbol transition time point; and
calculating an SNR value for a switching between an acquisition mode and a tracking mode from the sampled signal.

7. The timing error recovery method of claim 6, wherein the MMSE timing error detection is operative in the tracking mode.

8. The timing error recovery method of claim 6, wherein the switching between the acquisition mode and the tracking mode is decided by a decided preset SNR threshold.

9. The timing error recovery method of claim 6, the timing error value detecting step comprising the steps of:
finding a differential value that is a gradient between sample values of the signal sampled with the symbol sample rate;
generating a decision symbol error value by finding a difference between the symbol sample value and a decision value decided through the symbol sample value;
finding a conjugate value of the decision symbol error value;
multiplying the conjugate value by the differential value; and
finding a timing error value by calculating a real number value of the multiplied signal.

10. The timing error recovery method of claim 9, further comprising a step of comparing sizes of the sampled sample values.

11. The timing error recovery method of claim 10, further comprising the steps of:
if the compared sizes of the symbol sample values have an ascending or descending order pattern according to a sampled sequence, outputting a signal ‘1’;
otherwise, outputting a signal ‘0’; and
multiplying the signal ‘1’ or ‘0’ by the differential value.

12. The timing error recovery method of claim 6, further comprising a channel equalization step of compensating a signal distorted at the symbol sample rate by receiving the signal sampled with the symbol sample rate.

13. A timing error recovery apparatus comprising:
a differential value calculating unit a gradient between sample values of a signal sampled with a symbol sample rate;
a symbol error decision unit outputting a decision symbol error value by finding a difference between the symbol sample value and a decision value decided through the symbol sample value;
a conjugate operation unit finding a conjugate value of the decision symbol error value;
a multiplier multiplying the conjugate value by the differential value;
a real number seeking operation unit outputting a timing error signal by calculating a real number value of an output value of the multiplier; and
a symbol synchronization unit tuning a symbol synchronization by receiving the timing error signal and by adjusting a symbol-to-symbol transition time point.

14. The timing error recovery apparatus of claim 13, further comprising:
a comparison unit comparing sizes of the sampled sample values; and
a multiplier multiplying an output signal of the comparison unit by the differential value.

15. The timing error recovery apparatus of claim 14, the comparison unit comprising:
a plurality of subtracters receiving the sample values to find a difference between the sample values according to a sampled sequence; and
a comparator comparing the sizes of the sample values through the found difference, the comparator outputting a signal ‘1’ to the multiplier if the compared sizes of the symbol sample values have an ascending or descending order pattern according to a sampled sequence, the comparator outputting a signal ‘0’ to the multiplier, otherwise.

16. A timing error recovery apparatus comprising:
a timing error detector receiving a signal sampled with a symbol sample rate to detect a timing error value using MMSE timing error detection;
a symbol synchronization unit tuning a symbol synchronization by receiving the detected timing error value and by adjusting a symbol-to-symbol transition time point; and
an SNR estimator calculating an SNR value for a switching between an acquisition mode and a tracking mode from the sampled signal.

17. The timing error recovery apparatus of claim 16, further comprising a channel equalizer compensating a signal distorted at the symbol sample rate by receiving the signal sampled with the symbol sample rate.

18. The timing error recovery apparatus of claim 16, wherein the MMSE timing error detection is operative in the tracking mode.

19. The timing error recovery apparatus of claim 16, wherein the switching between the acquisition mode and the tracking mode is decided by a decided preset SNR threshold.

20. The timing error recovery apparatus of claim 16, further comprising:
a sampler sampling a received baseband signal with the symbol sample rate; and
a digital front-end processing unit performing a front-end processing on the sampled signal in a digital area.
